(19) United States
(12) Patent Application Publication
(10) Pub. No.: US 2006/0222382 A1
(43) Pub. Date: Oct. 5, 2006

(54) Minimum replenisher dispense strategy for improved xerographic stability

(75) Inventors: Barrett L. Gady, Washington, IA (US); Eric M. Gross, Rochester, NY (US); Palghat S. Ramesh, Pittsford, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/390,731

(22) Filed: Mar. 28, 2006

Related U.S. Application Data
(60) Provisional application No. 60/666,210, filed on Mar. 29, 2005.

(51) Int. Cl. G03G 15/08

(52) U.S. Cl. 399/27

(57) ABSTRACT

An electrostatic printing machine having a development station having a toner dispenser for dispensing toner in the development station and wherein the electrostatic printing machine employs a method for improving xerographic stability of condition the development station, including reviewing a print job comprising job images for toner usage; calculating a dispense rate base on the toner usage, print job attributes, and sensing toner quantity that is present; comparing the calculated dispense rate to a predefined minimum dispense rate; and if the calculated dispense rate is less than the predefined minimum dispense rate, setting the toner dispenser to the predefined minimum dispense rate; the setting includes scheduling a detone process if the toner mass in the development station exceeds a predefined threshold value.

### CROSS REFERENCE TO RELATED APPLICATION

This application claims the benefit of Provisional Patent Application No. 60/666,210, filed Mar. 29, 2005.

### BACKGROUND AND SUMMARY

The present invention generally relates to a digital imaging system. More specifically, the present invention provides an improved method and apparatus for controlling a toner dispenser to ensure image quality.

A copier, printer or other document-generating device typically employs an initial step of charging a photoconductive member to a substantially uniform potential. The charged surface of the photoconductive member is thereafter exposed to a light image of an original document to selectively dissipate the charge thereon in selected areas irradiated by the light image. This procedure records an electrostatic latent image on the photoconductive member corresponding to the informational areas contained within the original document being reproduced. The latent image is then developed by bringing a developer material including toner particles adhering triboelectrically to carrier granules into contact with the latent image. The toner particles are attracted away from the carrier granules to the latent image, forming a toner image on the photoconductive member, which is subsequently transferred to a copy sheet. The copy sheet having the toner image thereon is then advanced to a fusing station for permanently affixing the toner image to the copy sheet.

The approach utilized for multicolor electrophotographic printing is substantially identical to the process described above. However, rather than forming a single latent image on the photoconductive surface in order to reproduce an original document, as in the case of black and white printing, multiple latent images corresponding to color separations are sequentially recorded on the photoconductive surface. Each single color electrostatic latent image is developed with toner of a color corresponding thereto and the process is repeated for differently colored images with the respective toner of corresponding color. Thereafter, each single color toner image can be transferred to the copy sheet in superimposed registration with the prior toner image, creating a multi-layered toner image on the copy sheet. Finally, this multi-layered toner image is permanently affixed to the copy sheet in a substantially conventional manner to form a finished copy.

With the increase in use and flexibility of printing machines, especially color printing machines which print with two or more different colored toners, it has become increasingly important to monitor the toner development process so that increased print quality, stability and control requirements can be met and maintained. For example, it is very important for each component color of a multi-color image to be stably formed at the correct toner density because any deviation from the correct toner density may be visible in the final composite image. Additionally, deviations from desired toner densities may also cause visible defects in mono-color images, particularly when such images are half-tone images. Therefore, many methods have been developed to monitor the toner development process to detect present or prevent future image quality problems.

For example, it is known to monitor the developed mass per unit area (DMA) for a toner development process by using densitometers such as infrared densitometers (IRDs) to measure the mass of a toner process control patch formed on an imaging member. IRDs measure total developed mass (i.e., on the imaging member), which is a function of developability and electrostatics. Electrostatic voltages are measured using a sensor such as an ElectroStatic Voltmeter (ESV). Developability is the rate at which development (toner mass/area) takes place. The rate is usually a function of the toner concentration in the developer housing. Toner concentration (TC) is measured by directly measuring the percentage of toner by weight with respect to the weight of the developer in the developer housing which, as is well known, contains toner and carrier particles.

As indicated above, the development process is typically monitored (and thereby controlled) by measuring the mass of a toner process control patch and by measuring toner concentration (TC) in the developer housing. However, the relationship between TC and developability is affected by other variables such as ambient temperature, humidity and the age of the toner. For example, a three-percent TC results in different developabilities depending on the variables listed above. Therefore, in order to ensure good developability, which is necessary to provide high quality images, toner age must be considered.

These problems include low developability, high background, and halo defects appearing on sheets of support material. One method of managing the residence time of toner in the developer housing is to use a minimum area coverage (MAC) patch in the inter-page zone to cause a minimum amount of toner throughput which is disclosed in U.S. Pat. No. 6,047,142 which is hereby incorporated by reference.

As taught in that patent, during low area coverage runs, the development and transfer systems are stressed beyond their operating limits resulting in color drift, streaks, and development loss. The initial xerographic control implementation included a Minimum Area Coverage (MAC) patch algorithm. The minimum throughput is determined by calculating the average residence time of the toner in the development housing and is referred to as the toner age. The MAC patch algorithm starts printing patches in the IDZ whenever the toner age reaches a lower limit and then stops printing when the toner age reached an upper limit. It has been found that there are instances when the MAC patch algorithm's capability is insufficient to maintain material health during extended low area coverage runs, requiring additional material management control schemes to maintain adequate development and transfer performance. Consequently the auto toner purge algorithm (ATP) is implemented to better manage the material state during low area coverage. With auto toner purge enabled, the system will enter a dead cycle whenever the toner age exceeds an upper limit. The ATP routine will develop a predetermined number of high area coverage patches to cause the developer sump to be refreshed with new toner. The routine takes between 3 and 4 minutes to complete. This routine has been shown to be very effective at maintaining development and transfer performance during long runs of low area coverage. However, in order to maintain the system performance during low area coverage runs, the system requires frequent ATPs. A major drawback to auto toner purge mode is that the print productivity of the printing machine is substantially reduced as a result of image frames being lost in the deadcycle.

There is provided an electrostatic printing machine having a development station having a toner dispenser for dispensing toner in said development station and wherein the said electrostatic printing machine employs a method for improving xerographic stability of condition said development station, including reviewing a print job comprising job images for toner usage; calculating a dispense rate base on said toner usage, print job attributes, and sensing toner quantity that is present; comparing the calculated dispense rate to a predefined minimum dispense rate; and if said calculated dispense rate is less than said predefined minimum dispense rate, setting the toner dispenser to at least the said predefined minimum dispense rate; said setting includes scheduling a detone process if the toner mass in said development station exceeds a predefined threshold value.

In addition the reviewing includes performing a pixel count for each color plane on a sheet level of the print job; converting the pixel count to a percent area coverage per color plane; and in feed-forward mode comparing the area coverage per color plane to a dispense rate lookup table; and in a feed-back mode comparing the present toner mass to a desired toner mass set point. And, scheduling further includes measuring the TC in said developer station.

### BRIEF DESCRIPTION OF THE DRAWINGS

FIG. 1 is a partial schematic of an example of a print engine for a digital imaging system, which can employ the purge while run process of the present invention.

FIG. 2 is a flow chart showing the toner age calculation and the utilization of purge while run process of the present invention.

FIG. 3 is a layout showing one implementation of customer images, process control patches, MAC patches and purge patches on a photoreceptor.

### DETAILED DESCRIPTION

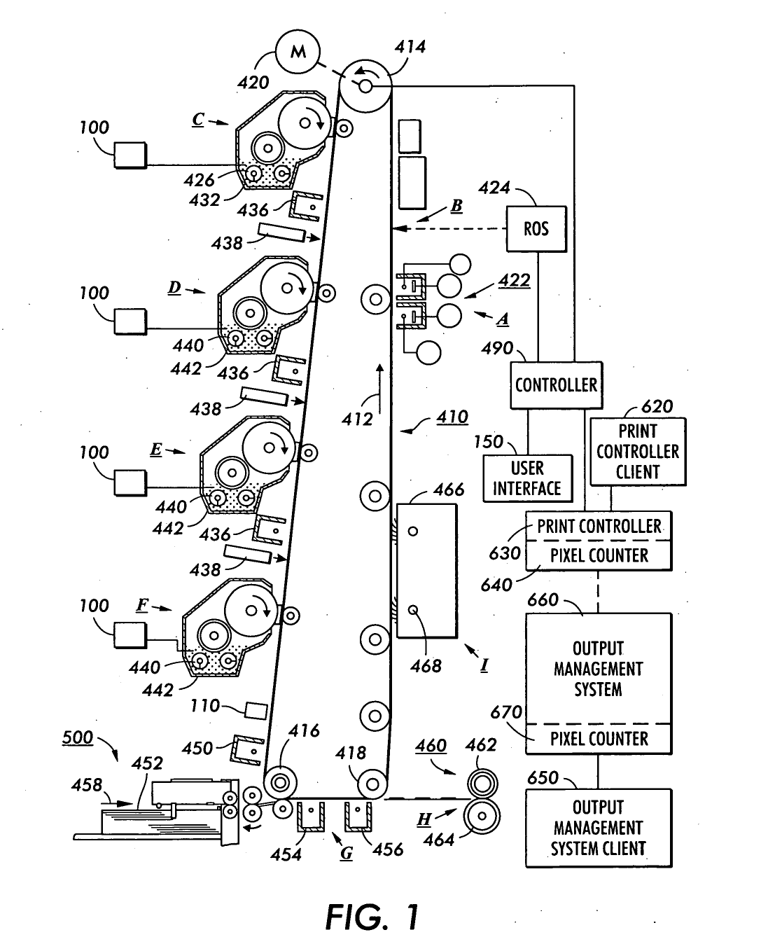

FIG. 1 is a partial schematic view of a digital imaging system, such as the digital imaging system of U.S. Pat. No. 6,505,832 which is hereby incorporated by reference. The imaging system is used to produce color output in a single pass of a photoreceptor belt. It will be understood, however, that it is not intended to limit the invention to the embodiment disclosed. On the contrary, it is intended to cover all alternatives, modifications and equivalents as may be included within the spirit and scope of the invention as defined by the appended claims, including a multiple pass color process system, a single or multiple pass highlight color system, and a black and white printing system.

In this embodiment, printing jobs are submitted from the Print Controller Client 620 to the Print Controller 630. A pixel counter 640 is incorporated into the Print Controller to count the number of pixels to be imaged with toner on each sheet or page of the job, for each color. The pixel count information is stored in the Print Controller memory. Job control information, including the pixel count data, and digital image data are communicated from the Print Controller 630 to the Controller 490. The digital image data represent the desired output image to be imparted on at least one sheet.

FIG. 1 additionally shows an alternative embodiment in which an Output Management System 660 may supply printing jobs to the Print Controller 630. Printing jobs may be submitted from the Output Management System Client 650 to the Output Management System 660. A pixel counter 670 is incorporated into the Output Management System 660 to count the number of pixels to be imaged with toner on each sheet or page of the job, for each color. The pixel count information is stored in the Output Management System memory. The Output Management System 660 submits job control information, including the pixel count data, and the printing job to the Print Controller 630. Job control information, including the pixel count data, and digital image data are communicated from the Print Controller 630 to the Controller 490. In this alternative embodiment, pixel counting in the Print Controller 630 is not necessary since the data has been provided with the job control information from the Output Management System 660.

The printing system preferably uses a charge retentive surface in the form of an Active Matrix (AMAT) photoreceptor belt 410 supported for movement in the direction indicated by arrow 412, for advancing sequentially through the various xerographic process stations. The belt is entrained about a drive roller 414, tension roller 416 and fixed roller 418 and the drive roller 414 is operatively connected to a drive motor 420 for effecting movement of the belt through the xerographic stations. A portion of belt 410 passes through charging station A where a corona generating device, indicated generally by the reference numeral 422, charges the photoconductive surface of photoreceptor belt 410 to a relatively high, substantially uniform, preferably negative potential.

Next, the charged portion of photoconductive surface is advanced through an imaging/exposure station B. At imaging/exposure station B, a controller, indicated generally by reference numeral 490, receives the image signals from Print Controller 630 representing the desired output image and processes these signals to convert them to signals transmitted to a laser based output scanning device, which causes the charge retentive surface to be discharged in accordance with the output from the scanning device. Preferably the scanning device is a laser Raster Output Scanner (ROS) 424. Alternatively, the ROS 424 could be replaced by other xerographic exposure devices such as LED arrays.

The photoreceptor belt 410, which is initially charged to a voltage V₀, undergoes dark decay to a level equal to about −500 volts. When exposed at the exposure station B, it is discharged to a level equal to about −50 volts. Thus after exposure, the photoreceptor belt 410 contains a monopolar voltage profile of high and low voltages, the former corresponding to charged areas and the latter corresponding to discharged or background areas.

At a first development station C, developer structure, indicated generally by the reference numeral 432 utilizing a hybrid development system, the developer roller, better known as the donor roller, is powered by two developer fields (potentials across an air gap). The first field is the ac field which is used for toner cloud generation. The second field is the dc developer field which is used to control the amount of developed toner mass on the photoreceptor belt 410. The toner cloud causes charged toner particles 426 to be attracted to the electrostatic latent image. Appropriate developer biasing is accomplished via a power supply. This type of system is a noncontact type in which only toner particles (black, for example) are attracted to the latent image and there is no mechanical contact between the photoreceptor belt 410 and a toner delivery device to disturb a previously developed, but unfixed, image. A toner concentration sensor 100 senses the toner concentration in the developer structure 432.

The developed but unfixed image is then transported past a second charging device 436 where the photoreceptor belt 410 and previously developed toner image areas are recharged to a predetermined level.

A second exposure/imaging is performed by device 438 which comprises a laser based output structure is utilized for selectively discharging the photoreceptor belt 410 on toned areas and/or bare areas, pursuant to the image to be developed with the second color toner. At this point, the photoreceptor belt 410 contains toned and untoned areas at relatively high voltage levels and toned and untoned areas at relatively low voltage levels. These low voltage areas represent image areas which are developed using discharged area development (DAD). To this end, a negatively charged, developer material 440 comprising color toner is employed. The toner, which by way of example may be yellow, is contained in a developer housing structure 442 disposed at a second developer station D and is presented to the latent images on the photoreceptor belt 410 by way of a second developer system. A power supply (not shown) serves to electrically bias the developer structure to a level effective to develop the discharged image areas with negatively charged yellow toner particles 440. Further, a toner concentration sensor 100 senses the toner concentration in the developer housing structure 442.

The above procedure is repeated for a third image for a third suitable color toner such as magenta (station E) and for a fourth image and suitable color toner such as cyan (station F). The exposure control scheme described below may be utilized for these subsequent imaging steps. In this manner a full color composite toner image is developed on the photoreceptor belt 410. In addition, a mass sensor 110 measures developed mass per unit area. Although only one mass sensor 110 is shown in FIG. 1, there may be more than one mass sensor 110.

To the extent to which some toner charge is totally neutralized, or the polarity reversed, thereby causing the composite image developed on the photoreceptor belt 410 to consist of both positive and negative toner, a negative pre-transfer dicorotron member 450 is provided to condition the toner for effective transfer to a substrate using positive corona discharge.

Subsequent to image development a sheet of support material 452 is moved into contact with the toner images at transfer station G. The sheet of support material 452 is advanced to transfer station G by a sheet feeding apparatus 500, described in detail below. The sheet of support material 452 is then brought into contact with photoconductive surface of photoreceptor belt 410 in a timed sequence so that the toner powder image developed thereon contacts the advancing sheet of support material 452 at transfer station G.

Transfer station G includes a transfer dicorotron 454 which sprays positive ions onto the backside of sheet 452. This attracts the negatively charged toner powder images from the photoreceptor belt 410 to sheet 452. A detack dicorotron 456 is provided for facilitating stripping of the sheets from the photoreceptor belt 410.

After transfer, the sheet of support material 452 continues to move, in the direction of arrow 458, onto a conveyor (not shown) which advances the sheet to fusing station H. Fusing station H includes a fuser assembly, indicated generally by the reference numeral 460, which permanently affixes the transferred powder image to sheet 452. Preferably, fuser assembly 460 comprises a heated fuser roller 462 and a backup or pressure roller 464. Sheet 452 passes between fuser roller 462 and backup roller 464 with the toner powder image contacting fuser roller 462. In this manner, the toner powder images are permanently affixed to sheet 452. After fusing, a chute, not shown, guides the advancing sheet 452 to a catch tray, stacker, finisher or other output device (not shown), for subsequent removal from the printing machine by the operator.

After the sheet of support material 452 is separated from photoconductive surface of photoreceptor belt 410, the residual toner particles carried by the non-image areas on the photoconductive surface are removed therefrom. These particles are removed at cleaning station I using a cleaning brush or plural brush structure contained in a housing 466. The cleaning brush 468 or brushes 468 are engaged after the composite toner image is transferred to a sheet. Once the photoreceptor belt 410 is cleaned the brushes 468 are retracted utilizing a device incorporating a clutch (not shown) so that the next imaging and development cycle can begin.

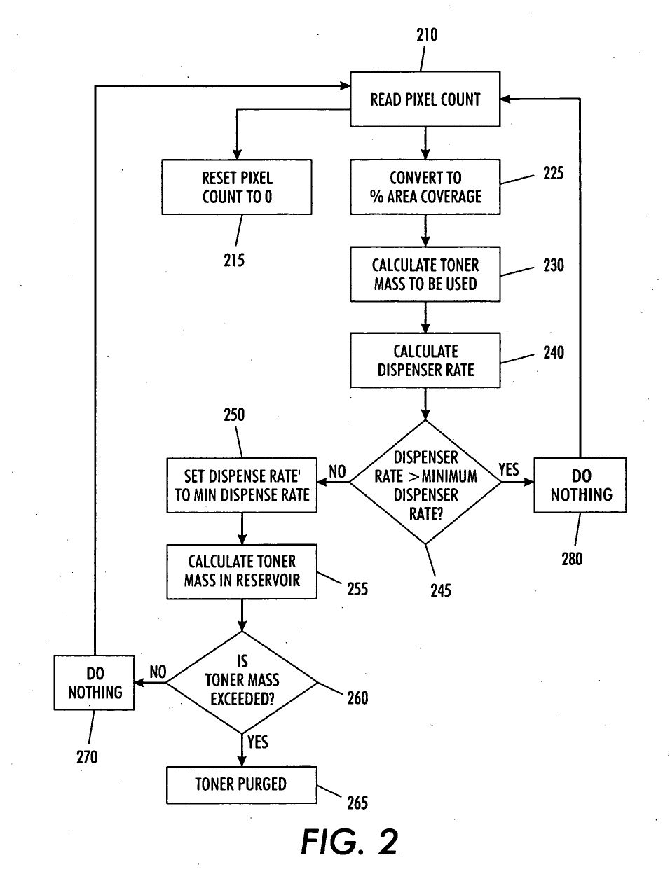

Controller 490 regulates the various printer functions. The controller 490 is preferably a programmable controller, which controls printer functions hereinbefore described. The controller 490 may provide a comparison count of the copy sheets, the number of documents being recirculated, the number of copy sheets selected by the operator, time delays, jam corrections, etc. The control of all of the exemplary systems heretofore described may be accomplished by conventional control switch inputs from the printing machine consoles selected by an operator. Conventional sheet path sensors or switches may be utilized to keep track of the position of the document and the copy sheets. The steps in the flow chart in FIG. 2 are repeated for each developer in FIG. 1 to measure the toner age.

Applications have found that dispense system that runs in a duty cycle mode for rates below 10%, can result in low area coverage print mode situations where the actual dispenser motor can be inactive over long time periods. The toner to carrier concentration may be at or above target levels, however, the residence time of the developer might be long enough to degrade both development and transfer. As a result, xerographic actuators such as development potential, cleaning field, and ROS power can exceed recommended limits. Customer print quality will be degraded as indicated by increased levels of development and transfer streaks and mottle. Currently, solution paths are to change developer packages, run large amounts of high area coverage images to flush the aged toner and carrier. More recently, a paperless toner purge process has been implemented.

Briefly, in the present invention, the impact of the above problems is significantly reduced by providing a system which can prevent a low area coverage failure mode from occurring due to a minimum rate of new replenisher. A proposed modification to the current algorithm is to have the dispense motor active at all times and set to at least a specified lower limit. The lower limit being a minimum dispense rate greater than or equal to what is required for level 1 and 2 control patches and emissions. In the event that there is an excessive TC that can occur at low area coverages, a detone process is provided to avoid 10 and emission failure modes.

Now referring to FIG. 2 which is a flow chart showing the process that calculates toner dispense rate and takes appropriate action based upon the results of the toner dispense rate calculation. The process starts at step 205. The control unit 30 reviews a print job comprising job images for toner usage (step 210) which includes reading the pixel count for the print job, and the pixel counter is reset to zero (step 215) at the end of the print job. The pixel count is converted into percent area coverage (step 225) by control unit 30 in this process includes performing a pixel count for each color plane on a sheet level of the print job; converting the pixel count to a percent area coverage per color plane. Then, control unit 30 calculates the amount of toner to be used for the print job and the dispense rate (step 230 and 240). Control unit 30 calculates calculating a dispense rate base on the toner usage, print job attributes, and sensing toner quantity that is present in the housing. Control unit 30 compares the calculated dispense rate to a predefined minimum dispense rate (step 245) and if the calculated dispense rate is less than the predefined minimum dispense rate, setting the toner dispenser to the predefined minimum dispense rate; the setting includes scheduling a detone or purge process if the toner mass in the development station exceeds a predefined threshold value (step 290 and 265). Step 245 also includes employing a feed-forward mode comparing the area coverage per color plane to a dispense rate lookup table; and in a feed-back mode comparing the present toner mass to a desired toner mass set point such as disclosed in application Ser. No. 11/169,715, entitled “SYSTEM FOR ACTIVE TONER CONCENTRATION TARGET ADJUSTMENTS AND METHOD TO MAINTAIN DEVELOPMENT PERFORMANCE”, filed Jun. 30, 2005 and application Ser. No. 11/088,554, entitled “FEED FORWARD AND FEEDBACK TONER CONCENTRATION CONTROL UTILIZING POST TRANSFER SENSING FOR TC SET POINT ADJUSTMENT FOR AN IMAGING SYSTEM, filed Mar. 24, 2005, both of which are hereby incorporated by reference. The scheduling (step 260) includes printing a MAC patch with the developer station to purge toner step 265. Applicants have found that setting the predefined minimum dispense rate at greater than or equal to the toner consumption level of interdocument control patches and emissions to be beneficial for maintaining image quality.

Toner mass is determine (step 255) in the developer housing by measuring the TC. Preferably, the control unit 30 reads the toner concentration (TC) every n seconds, wherein n is a positive number, and this number is stored in memory. The control unit 30 reads the developed mass per unit area (DMA), sensed by mass sensor 110, and stores the DMA in memory. The control unit 30 calculates the toner amount used since the last toner concentration was read by using the DMA target stored in memory.

Subsequently, the current toner mass in developer unit 90 is calculated by control unit 30 by using the following formula:
Current Toner Mass=(toner concentration/100)*carrier mass

The carrier mass varies depending upon the print engine, and is generally determined by the manufacturer based on a number of factors including size of print engine, toner stability, speed of print engine, etc.

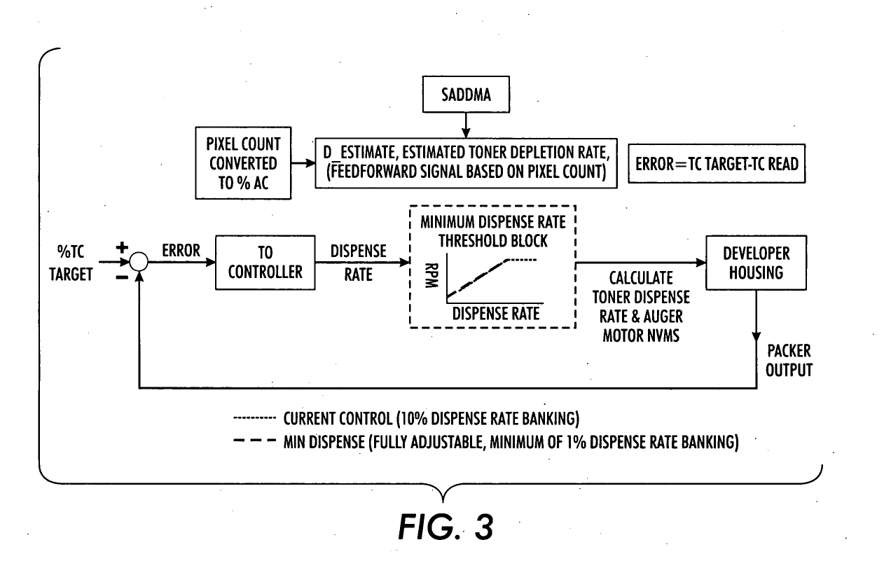

FIG. 3 illustrates TC control feedback loop as employed in a printing machine.

It is an example of one possible instantiation of utilizing the toner dispense profile as a xerographic actuator. At the output of the TC controller block is the dispense rate command. The dispense rate command is then passed to a limiter, which in this particular illustration does not permit the actual dispense command to go below a minimum positive threshold (the output being sent to the dispense motor in terms of rpm—revolutions per minute). Minimum dispense rate can be made a function of estimated toner age (average resident time, environmental conditions, and such). In addition to the predefined minimum dispense, the controller can be such so as to ensure that the toner dispense function vs. time has characteristics that are beneficial for xerographic stability and image quality. The constraints can be dynamic or varied over time depending on operating conditions. For example, the toner dispense rate of increase or the toner dispense rate of decrease might be constrained.

While the invention has been described in detail with reference to specific and preferred embodiments, it will be appreciated that various modifications and variations will be apparent to the artisan. All such modifications and embodiments as may occur to one skilled in the art are intended to be within the scope of the appended claims.

What is claimed is:

1. An electrostatic printing machine having a development station having a toner dispenser for dispensing toner in said development station and wherein the said electrostatic printing machine employs a method for improving xerographic stability of toner in said development station, comprising:
reviewing a print job comprising job images for toner usage;
calculating a dispense rate base on said toner usage, print job attributes, and sensing toner quantity that is present;
comparing the calculated dispense rate to a predefined minimum dispense rate; and
if said calculated dispense rate is less than said predefined minimum dispense rate, setting the toner dispenser to said predefined minimum dispense rate; said setting includes scheduling a detone process if the toner mass in said development station exceeds a predefined threshold value.

2. The printing machine of claim 1, further including varying said predefined minimum dispense rate as a function of time.

3. The printing machine of claim 1, further including varying said predefined minimum dispense rate as a function of estimated toner age.

4. The printing machine of claim 1, wherein said reviewing includes:
performing a pixel count for each color plane on a sheet level of the print job; converting the pixel count to a percent area coverage per color plane; and
in feed-forward mode comparing the area coverage per color plane to a dispense rate lookup table; and
in a feed-back mode comparing the present toner mass to a desired toner mass set point.

5. The printing machine of claim 1, wherein said scheduling includes printing a MAC patch with said developer station.

6. The printing machine of claim 5, wherein said scheduling further includes measuring the TC in said developer station.

7. A method for improving xerographic stability of toner in a development station, comprising:
reviewing a print job comprising job images for toner usage;
calculating a dispense rate base on said toner usage, print job attributes, and sensing toner quantity that is present;
comparing the calculated dispense rate to a predefined minimum dispense rate; and
if said calculated dispense rate is less than said predefined minimum dispense rate, setting the toner dispenser to said predefined minimum dispense rate; said setting includes scheduling a detone process if the toner mass in said development station exceeds a predefined threshold value.

8. The method of claim 7, further including varying said predefined minimum dispense rate as a function of time.

9. The method of claim 7, further including varying said predefined minimum dispense rate as a function of estimated toner age.

10. The method of claim 1, wherein said reviewing includes:
performing a pixel count for each color plane on a sheet level of the print job; converting the pixel count to a percent area coverage per color plane; and
in feed-forward mode comparing the area coverage per color plane to a dispense rate lookup table; and
in a feed-back mode comparing the present toner mass to a desired toner mass set point.

11. The method of claim 1, wherein said scheduling includes printing a MAC patch with said developer station.

12. The method of claim 11, wherein said scheduling further includes measuring the TC in said developer station.
